(19) United States
(12) Patent Application Publication
(10) Pub. No.: US 2008/0177646 A1
(43) Pub. Date: Jul. 24, 2008

(54) Work site remote monitoring and employee time tracking system and method

(75) Inventor: Bentley D. Frink, Wilmington, NC (US)

Correspondence Address: WILLIAM J. MASON;MACCORD MASON PLLC, POST OFFICE BOX 1489, WRIGHTSVILLE BEACH, NC, 28480, US

(73) Assignee: Property Monitors, Inc.

(21) Appl. No.: 12/009,674

(22) Filed: Jan. 22, 2008

Related U.S. Application Data
(60) Provisional application No. 60/881,209, filed on Jan. 19, 2007.

(51) Int. Cl. G06Q 10/00; G06F 7/04

(52) U.S. Cl. 705/32; 340/5.53

(57) ABSTRACT

A work site monitoring and employee time tracking system that includes a work site Internet connection having a broadband modem in communication with a router for transporting data to and from the work site and a work site IP camera in communication with the router for transporting images from the work site to client computers in communication with the Internet. A biometric fingerprint scanner for identifying and clocking-in and clocking-out work site workers is also included. The biometric scanner is in communication with the router for transmitting identification, clock-in and clock-out data to a server computer in communication with the Internet.

This application claims priority to U.S. provisional application Ser. No. 60/881,209 filed Jan. 19, 2007, the entire contents of which are incorporated herein by reference.

### BACKGROUND OF THE INVENTION

1. Field of the Invention

The present invention relates to a system and method for remotely gathering information from work sites such as construction sites. In particular, the present system and method provides work site remote monitoring and worker clock-in and clock-out data collection over the Internet.

2. Description of the Prior Art

Work sites such as construction sites are typically chaotic work places that have many arrivals and departures of various work crews during a work period. As a result, it is very difficult to track the onsite job time of workers that typically spend uneven amounts of a work period on multiple work sites. Moreover, construction sites, and in particular residential home construction sites can be temporarily abandoned while workers wait on such things as materials, favorable weather conditions and construction permits. Consequently, construction site security is frequently left to chance.

There are prior art attempts at addressing security and employee management for work sites such as enterprise construction sites by using cameras and employee identification, but the use of such systems for residential home construction sites has been slow in adoption due to their inflexibility and cost. What is needed is a flexible and inexpensive system and method that is usable to efficiently track employee work-time as well as allow for remote visual monitoring of a work site such as a residential home construction site.

### SUMMARY OF THE INVENTION

The present invention provides a system and method that addresses the tracking of employee work-time at work sites such as residential home construction sites along with the remote monitoring of the work site using sensors adapted to transmit data over the Internet. In general, the present system and method integrates image sensors such as biometric finger scanners and processors together with internet protocol cameras over a wide area network that includes routers, modems, servers, clients and software to provide real-time remote time-tracking of employee work-time along with remote visual work site monitoring.

In particular, the preferred system of the present invention includes a broadband Internet connection at a work site to be monitored. The work site Internet connection is preferably a broadband connection like those offered by cable companies via broadband cable modems or digital subscriber lines (DSL) offered by traditional telephone companies via broadband DSL modems. Moreover, broadband wireless Internet connections such as those offered by wireless telecoms are attractive for use with low infrastructure sites such as those in the beginning of construction.

The system further includes a server computer programmed with software to communicate with Internet protocol adapted equipment that is deployable at the work site. The equipment includes but is not limited to biometric authentication scanners for identifying employees, sensors interfaced with energy efficient transceivers for collecting work site data, and a bridging device for gathering the collected data and then transmitting it over the Internet to the server, and Internet protocol cameras for transmitting live images of the work site to a manager having a client computer in communication with the cameras. The manager's client computer can directly communicate with the cameras or can indirectly communicate with them through a video-rebroadcast server and/or through the server. The preferred system also includes a router that communicates with the work site's broadband modem. The router controls the flow of data to and from the work site's Internet protocol adapted equipment. As a result of some of the equipment being wireless, the preferred router is capable of both wireless and Ethernet communication.

For the purposes of this disclosure, biometric authentication refers to technologies that measure and analyze human physical characteristics for identification and authentication purposes. Examples of biometric characteristics usable for identification and authentication include but are not limited to fingerprints, eye retinas and irises, facial patterns and hand measurements. The preferred biometric identification and authentication means of the present invention is an electronic fingerprint scanner having a built-in TCP/IP firmware stack for controlling the transfer of identification and authentication data over the Internet to the server. The fingerprint scanner sensor can be either the optical or capacitor type.

The fingerprint scanner is housed in a weatherproof enclosure that preferably includes an electric latch that unlocks the enclosure during work hours and also locks the enclosure during non-work hours. The latch is preferably controllable over the Internet, so that overtime access to the scanner is possible and for maintaining the enclosure's latch state if the work site is abandoned. The scanner can be assigned a local area network (LAN) address by the router during system power-up. Alternately, the scanner can be manually assigned a static IP address. The router includes a translation table or its equivalent for using the assigned LAN address to pass data to and from the scanner over the Internet.

In operation, the scanner's electric latch unlocks the scanner enclosure at the beginning of each workday. Employees establish the beginning of their work period (i.e., clock-in) by pressing their index finger's print against the scanner's scanning surface. At that moment, the scanner electronically compares specific features of the present employee's fingerprint with a database of fingerprint features that match known employees. If an identifying match is made, an identifying label along with period beginning time and date stamp is transmitted to the server to be placed in an employee job-time database. Each employee will establish the end of their work period for a particular work site by once again by pressing their index finger's print against the scanner's scanning surface. Once an identifying match is made an identifying label along with a work period ending time and date stamp is transmitted to the server to be placed in an employee job-time database. Payroll reports and other business related reports are automatically generatable by server software and/or web services having access to the employee job-time database.

The IP cameras at the work site are pan, tilt and zoom (PTZ) cameras or fixed cameras or combinations thereof. Fixed cameras are usable to view and monitor fixed objects of value whereas PTZ cameras are usable to track moving objects such as individuals. It is preferred that motion detection algorithms are usable with both camera types. The motion detection algorithms can be included in the cameras' firmware or can be server based. It is also preferred for the PTZ cameras to include camera PTZ control algorithms that communicate with the motion control algorithms to track a detected object. Moreover, the cameras can include infrared cut filters for preventing ambient infrared from causing chromic interference during daylight. Nighttime cameras can be used without infrared cut filters. In an alternate embodiment, the cameras can be equipped with servo mounted infrared cut filters or other filters such that the filters can be automatically moved in front of and away from the camera lens in response to ambient light conditions. Further still, infrared lamps can be deployed at the work site such that they shine infrared light on objects to be viewed at night by the cameras not having infrared cut filters.

The PTZ IP camera of the present invention is housed in a weatherproof optical plastic or glass dome that is mounted to a pole or building structure. Fans and/or heaters in communication with the dome keep the camera within its operational temperature range at all times. The fixed IP cameras are housed in a weatherproof housing having an optical plastic or glass window.

Preferably, at least some of the present system's IP cameras are enabled to capture video at a rate that is greater than or equal to 30 frames per second. It is also preferred that the fixed IP cameras useable with the present system have megapixel image sensors that allow a digital pan tilt zoom emulation. An example of such a fixed IP camera is the IQEYE 755 five megapixel camera sold by Iqinvision™. It is also preferred that video compression is employed to lessen bandwidth requirements. A Motion-JPEG type video compression is generally acceptable. Moreover, it is beneficial for each PTZ camera to include viewer software that gives a user full remote control of each PTZ camera's pan angle, tilt angle and zoom magnification.

An example of a suitable PTZ IP camera for use with the present invention is the VB-C50iR Canon™ network camera, which has a high-performance 26× optical zoom, and a pan angle range of at least 200 degrees. Generally, it can pan 100 degrees to the left of center and 100 degrees to the right of center. Its tilt angle range is at least 100 degrees, typically being 10 degrees in an upward direction and 90 degrees in a downward direction or vice versa, depending on how the camera is mounted.

A low power radio network of transceivers interfaced to environmental sensors can be further utilized to monitor conditions at the work site. The preferred low power network is made up of IEEE 802.15.4 transceivers programmed to use a self healing mesh network protocol such as the ZIGBEE™ protocol. The IEEE 802.15.4 specified transceivers allow for sensor data to be gathered from a work site at a data rate of up to 250 kbps while maintaining a very long battery life of months or years at low transmission volumes. A Zigbee™ to Internet bridging device is usable to transmit data to and from the Zigbee™ mesh network over the Internet. One such bridging device is the Q52 Zigbee™ Bridge Device manufactured by EXEGIN TECHNOLOGIES LTD of Port Coquitlam, BC, Canada V3C6N2. The Q52 facilitates communication between servers and 802.15.4 Zigbee™ radios by way of Internet protocols such as HTTP, FTP and SNMP. These capabilities allow seamless connections of distant mesh networks over any TCP/IP network to form a single widely distributed personal area network (PAN).

Alternately, the low power radio network transceivers can be directly interfaced with a wireless router operating under the IEEE 802.11b/g standard. For example, a new class of WiFi sensors using the IEEE 802.11b/g standard are battery powered and can transmit data for periods measured in years on a single AA size 3.3V lithium battery. One company, GainSpan Corporation of 440 N. Wolfe Road Sunnyvale, Calif. 94085 manufactures a system on chip integrated circuit known as the GS1010. The GS1010 and associated software provides years of life and intelligent power management for battery operated devices such as those that could make up sensors 22 and 26 of the present invention.

Environmental sensors that can be interfaced with the transceivers can be practically any sensors having an analog or digital output. Sensors of interest for the present invention include but are not limited to those that measure temperature, pressure, humidity, sound waves, ionizing and non-ionizing radiation, smoke, open flames, infrared emissions, magnetic fields, chemical content and biological activity. Moreover, combinations of such sensors could be used to monitor buildings for pests such as termites. In this case, a Zigbee™ network would be built into the foundation of a building for termite monitoring over the life of the building. Such a network would also be usable to monitor for water leaks, corrosion and mold in the crawl spaces under a building as well as other difficult to inspect areas. Further still, very low cost and energy efficient CMOS camera sensors could be interfaced with the mesh network to provide long term periodic visual inspection of high value but difficult to inspect locals within a building.

The preferred low power CMOS camera sensor for the present invention operates at 3.3 Vdc voltage supply at a normal operating current of 60 mA and a sleep current of only 100 uA. Moreover, the CMOS camera sensor's circuit board has dimensions of 20×28 mm with a weight of only 3 grams. Also, the circuit board includes a JPEG CODEC to compress a captured image before transmission. Pictures captured by the CMOS camera sensor at a 640×480-image resolution (VGA) can be transmitted at 115.2 kbps.

The present invention incorporates passive infrared sensors (PIR) interfaced with the low power radio network. Security monitoring is enhanced over prior art systems through the use of this PIR sensor network in combination with the IP cameras. In an exemplary scenario, the PIR sensor network is deployed in monitoring pattern about the work site. As humans approach individual PIR sensors their body heat will pass a triggering threshold that is predetermined for optimum detection. Detection will take place and the PIR sensor network will pass a detection signal through the Zigbee™ bridge device over the Internet to the server. The server will in turn take control of the nearest PTZ camera and move it to focus on the area of the detection. The server will then record images of the detection scene streaming from selected PTZ cameras. If the motion detection algorithms of the cameras detect motion, the PTZ cameras will automatically follow the moving object until the moving object is outside the range of the cameras' view. The video can be recorded on a server's storage medium. At present, server hard disk drives have individual storage capacity in the terabyte range. Therefore, the use of the cameras' video compression capability makes realizable the possibility of recording months of non-stop video.

The server is also preferably programmed to send notification to appropriate persons that a security breach or hazard at the work site has occurred. For example, the server is programmable to send an email alert to a cellular phone and other Internet capable devices. Moreover, the server is preferably programmed to place a phone call to present a spoken message to appropriate persons. The message can be a pre-recorded message or a computer synthesized message that notifies an appropriate person that a security breach or hazard has occurred at the work site. Further still the server is programmable to snap still photos from all the cameras at the work site on a scheduled basis. The PTZ cameras have the added benefit being controllable to snap sets of panoramic images on command. These panoramic images or scenes are usable to give a remote work site manager a quick overview of the work site for any given time period.

Adding radio frequency identification (RFID) capability to the low power radio network provides added security. In the preferred embodiment, active RFID tags are attached to items of value within the work site area. The RFID tags periodically report their presence over the low power radio network. These reporting actions allow a remote work site manager to account for valuable equipment at the work site. Moreover, the most valuable equipment is secured using geo-fencing by interfacing global positioning system (GPS) modules with the low power radio network. The GPS modules are programmed to transmit an alarm over the low power radio network if they sense movement that takes them outside a predetermined range. Further still tilt-sensors and/or accelerometers are interfaceable with the low power radio network to perform a similar task. Other attributes and features of the present invention will become apparent in the following detailed preferred embodiment description.

### BRIEF DESCRIPTION OF THE DRAWINGS

In the following drawings like reference characters in the same or different figures indicate like parts.

FIG. 1 shows map views of a work site and remote server and client site illustrating the deployment of the present system.

FIG. 2 is a server program to control the PTZ camera in response to signals sent from the PIR sensors interfaced to the low power network.

### DETAILED DESCRIPTION OF THE PREFERED EMBODIMENT

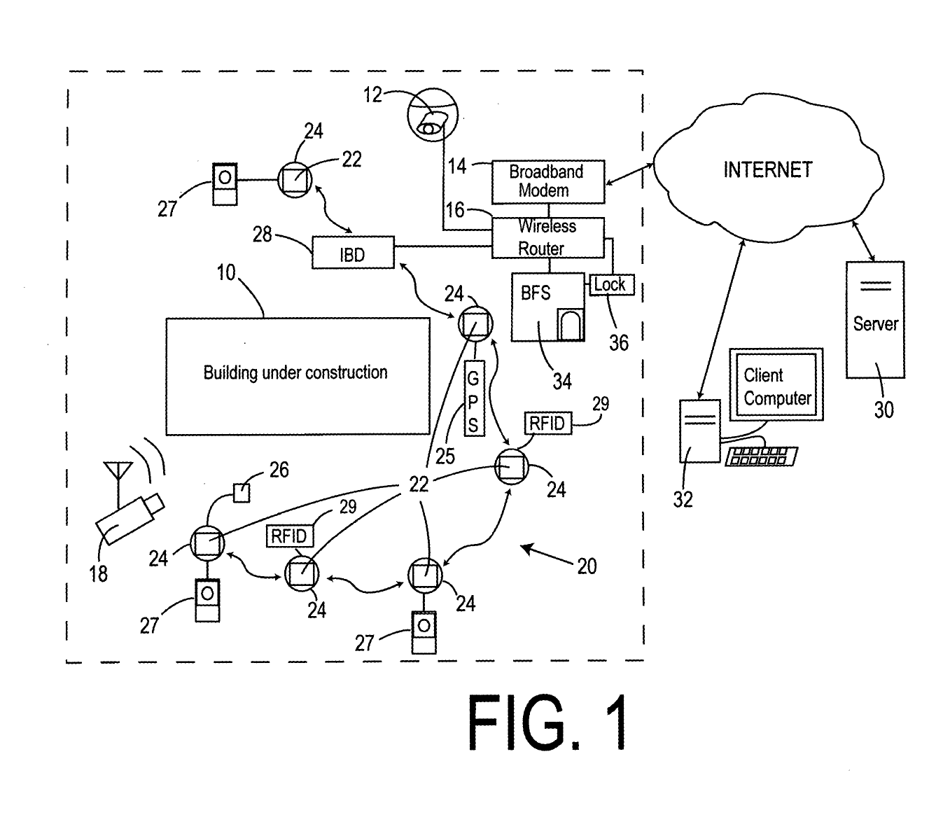

FIG. 1 shows a work site area represented inside a dashed box. A building 10 under construction is monitored by a PTZ IP camera 12 that is interfaced with the Internet through an Internet connection having a broadband modem 14 and a wireless router 16. A fixed wireless IP camera 18 is located to stream images of the work site that are outside the camera view of PTZ IP camera 12.

A low power radio network, generally 20 is made up of IEEE 802.15.4 transceivers 22. A plurality of transceivers 22 is interfaced with PIR sensors 24, which are arranged in a detection pattern. A global positioning system module 25 is attachable to equipment for preventing theft through the use of geo-fencing techniques that periodically sends geo-location data over the low power radio network. If the equipment is moved outside a predetermined boundary, an alarm is sent through transceivers 22 to IBD 28, router 16 and broadband modem 14 to the Internet.

One of transceivers 22, as depicted in FIG. 1 is also interfaced with a sensor 26 for detecting other physical or chemical properties that might indicate a water leak or biological activity associated with mold or termite activity. Moreover, low power CMOS camera sensors 27 interface with transceivers 22. CMOS camera sensors 27 have an operating current of about 60 mA and a sleep current of about 100 uA. Low power radio network 20 also includes an Internet bridging device (IBD) 28 for passing data over the Internet to and from transceivers 22. RFID tags 29 that are attachable to items of value also pass tag identification data through transceivers 22 to IBD 28, router 16 and broadband modem 14 to the Internet.

A server 30 receives and processes the data transmitted through low power network 20. A client computer 32 displays data processed by server 30. Server 30 also records video and archives still images taken by PTZ IP camera 12 and fixed IP camera 18. Client computer 32 is usable to display video recorded and archived by server 30. Moreover, client computer 30 is usable to control PTZ IP camera 12 in real-time.

A biometric fingerprint scanner (BFS) 34 is interfaced with the Internet. Scanner 34 is used by work site employees to check-in and check-out of the work site. Server 30 stores each employee's identification along with their work site check-in and check-out time. A lock for locking an enclosure housing biometric fingerprint scanner 34 can be locked and unlocked remotely over the Internet via commands sent from a client computer in communication with broadband modem 14 and wireless router 16.

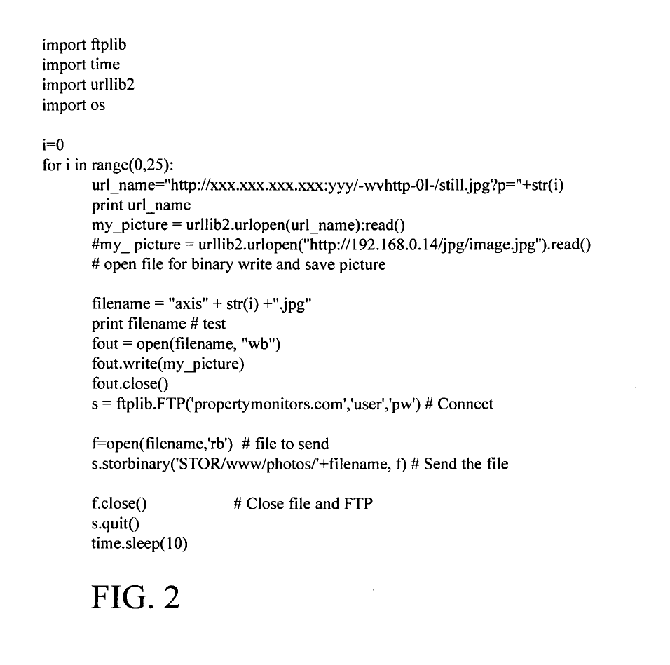

FIG. 2 is an example of a software program that is resident on server 30. On reception of an alarm from the PIR interfaced low power radio network 20, the program of FIG. 2 is executable to record images from the detection area. The program is written in the Python scripting language.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A work site monitoring and employee time tracking system comprising:
a) a work site Internet connection having a broadband modem in communication with a router for transporting data to and from the work site;
b) a work site IP camera in communication with said router for transporting images from the work site to client computers in communication with the Internet; and
c) a biometric fingerprint scanner for identifying and clocking-in and clocking-out work site workers, said biometric scanner being in communication with said router for transmitting identification, clock-in and clock-out data to a server computer in communication with the Internet.

2. The work site monitoring and employee time tracking system of claim 1, further including a work site low power radio system having a plurality transceivers interfaced with sensors for detecting physical and/or chemical properties of the work site environment and an Internet bridge device for transporting sensor data from said sensors to said server computer.

3. The work site monitoring and employee time tracking system of claim 2, wherein said sensors are passive infrared sensors having a detection area for detecting the body heat of individuals passing within the sensors' detection areas.

4. The work site monitoring and employee time tracking system of claim 1, wherein employee payroll reports are automatically generatable by server software and/or web services having access to an employee job-time database that is communicable with said biometric fingerprint scanner.

5. The work site monitoring and employee time tracking system of claim 2, further including a plurality of low power CMOS camera sensors interfaceable with said low power radio network.

6. The work site monitoring and employee time tracking system of claim 2, further including active radio frequency tags interfaceable with said low power radio network, said active radio frequency tags being attachable to items of value within the work site area.

7. The work site monitoring and employee time tracking system of claim 2, further including global position system modules interfaceable with said low power radio network, said global positioning system modules being attachable to items of value within the work area and said global position systems modules being programmed transmit geo-location data over said low power network through said Internet bridge device, router and modem to said server.

8. The work site monitoring and employee time tracking system of claim 1, wherein said server is programmed to send an email notification to predetermined persons in the event of a security breach or other detected hazard at the work site.

9. The work site monitoring and employee time tracking system of claim 1, wherein said server is programmed to play a pre-recorded message or a computer synthesized message that notifies predetermined persons in the event of a security breach or other detected hazard at the work site.

10. A work site monitoring and employee time tracking system comprising:
a) a work site Internet connection having a broadband modem in communication with a wireless router for transporting data to and from the work site;
b) a work site IP camera in communication with said router for transporting images from the work site to client computers in communication with the Internet;
c) a biometric fingerprint scanner for identifying and clocking-in and clocking-out work site workers, said biometric scanner being in communication with said router for transmitting identification, clock-in and clock-out data to a server computer in communication with the Internet; and
d) a work site low power radio system having a plurality transceivers interfaced with sensors for detecting physical and/or chemical properties of the work site environment and an Internet bridge device for transporting sensor data from said sensors to said server computer.

11. The work site monitoring and employee time tracking system of claim 10, wherein said server is programmed to send an email notification to predetermined persons in the event of a security breach or other detected hazard at the work site.

12. The work site monitoring and employee time tracking system of claim 10, wherein said sensors are passive infrared sensors having a detection area for detecting the body heat of individuals passing within the sensors' detection areas.

13. The work site monitoring and employee time tracking system of claim 10, wherein employee payroll reports are automatically generatable by server software and/or web services having access to an employee job-time database that is communicable with said biometric fingerprint scanner.

14. The work site monitoring and employee time tracking system of claim 10, further including a plurality of low power CMOS camera sensors interfaceable with said low power radio network.

15. The work site monitoring and employee time tracking system of claim 10, further including active radio frequency tags interfaceable with said low power radio network, said active radio frequency tags being attachable to items of value within the work site area.

16. The work site monitoring and employee time tracking system of claim 10, further including global position system modules interfaceable with said low power radio network, said global positioning system modules being attachable to items of value within the work area and said global position systems modules being programmed transmit geo-location data over said low power network through said Internet bridge device, router and modem to said server.

17. The work site monitoring and employee time tracking system of claim 10, further including RFID tags in communication with the Internet via said low power radio network, wireless router and broadband modem.

18. The work site monitoring and employee time tracking system of claim 10, wherein said server is programmed to play a pre-recorded message or a computer synthesized message that notifies predetermined persons in the event of a security breach or other detected hazard at the work site.

19. The work site monitoring and employee time tracking system of claim 10, wherein said IP camera includes firmware based motion detection algorithms.

20. The work site monitoring and employee time tracking system of claim 10, wherein said low power radio network interfaces directly with said wireless router.
